(19) United States
(12) Patent Application Publication
(10) Pub. No.: US 2008/0059485 A1
(43) Pub. Date: Mar. 6, 2008

(54) Systems and methods for entering and retrieving data

(76) Inventor: James Patrick Finn, Burnsville, MN (US)

Correspondence Address: James Patrick Finn III, 2800 Woods Trail North, Burnsville, MN, 55306, US

(21) Appl. No.: 11/895,290

(22) Filed: Aug. 23, 2007

Related U.S. Application Data
(60) Provisional application No. 60/823,374, filed on Aug. 23, 2006.

(51) Int. Cl. G06F 17/30

(52) U.S. Cl. 707/10; 707/E17.001

(57) ABSTRACT

This document provides systems and methods for entering and retrieving data. For example, systems and methods that can allow providers to enter information about available (e.g., assignable or licensable) intellectual property into a searchable database accessible to users having an interest in buying or licensing intellectual property are provided. In addition, systems and methods that can allow users to search for specific intellectual property opportunities in a quick and efficient manner are provided.

### CROSS-REFERENCE TO RELATED APPLICATIONS

This application claims priority to U.S. Provisional Application No. 60/823,374, filed Aug. 23, 2006, which is incorporated by reference in its entirety.

### BACKGROUND

1. Technical Field

This document relates to systems and methods for entering and retrieving data. For example, this document relates to systems and methods that can allow providers to enter information about available (e.g., assignable or licensable) intellectual property into a searchable database accessible to users having an interest in licensing intellectual property.

2. Background

Many different databases listing issued patents and published patent applications exist. For example, the United States Patent and Trademark Office provides a database of issued U.S. patents and published U.S. patent applications. Such databases typically provide keyword searching capabilities based on the specific content disclosed in the issued patent or published patent application.

### SUMMARY

This document provides systems and methods for entering and retrieving data. For example, this document relates to systems and methods that can allow providers to enter information about available (e.g., assignable or licensable) intellectual property into a searchable database accessible to users having an interest in buying or licensing intellectual property. The systems and methods provided herein can allow a provider to enter identifying characteristics of available (e.g., assignable or licensable) intellectual property in a quick and verifiable manner. Such identifying characteristics can include, without limitation, the title, listed inventors, serial number, and filing date of a pending patent application. The systems and methods provided herein also can allow a provider to provide additional information about the intellectual property that could be useful to a potential assignee or licensee. Such additional information can include, without limitation, information about the availability of an exclusive or non-exclusive license, information about the presence of a commercial product, information about the stage of research being conducted (e.g., the stage of a pre-clinical or clinical trial involving a patented drug or treatment), and information about prior art or freedom to operate search results. In some embodiments, the systems and methods provided herein can allow a provider to control the degree of access to specific information about the provider's intellectual property.

The systems and methods provided herein also provide users with the ability to search for specific intellectual property opportunities in a quick and efficient manner. For example, a user interested in investing in an asthma treatment can search for issued or pending patent applications that meet a set of pre-defined criteria such as (1) the availability of an exclusive license, and (2) the completion of stage 2, FDA clinical trials. In this example, the systems and methods provided herein can provide the user with a list of licensable intellectual property meeting these criteria without returning a long list of issued or published patent applications that merely contain the word “asthma.” In another example, a user interested in investing in a breast cancer treatment can search for intellectual property opportunities that meet a set of pre-defined criteria such as (1) unpublished, pending patent applications, (2) the availability of an exclusive license, (3) identification of lead treatment compound, (4) the presence of positive treatment data from an animal model, and (5) the completion of toxicity studies in animals. In this example, the systems and methods provided herein can provide the user with a meaningful list of licensable intellectual property not available from public databases that are typically limited to issued or published patent applications.

In general, one aspect of this document features a method for entering intellectual property information into a database of available intellectual property. The method comprises, or consists essentially of, (a) presenting a provider with a provider interface for entering information about intellectual property available for sale or license, (b) receiving information entered into the provider interface by the provider, and (c) storing the received information of step (b) in a database for retrieval by a user. The provider interface can comprise an entry field for an identifying characteristic of the intellectual property to be entered. The identifying characteristic can be selected from the group consisting of a patent number, a patent application serial number, a patent application publication number, a patent title, and a patent application title. Step (b) of the method can comprise receiving a patent number or application serial number of an issued patent or a serial or publication number of a published patent application. The method can comprise accessing a public database containing the issued patent or the published patent application to obtain public information about the patent or the published patent application. The method can comprise presenting the provider with an updated provider interface comprising a field populated with information obtained from the public database. The method can comprise receiving the patent number or application serial number of the issued patent, and the information obtained from the public database can be selected from the group consisting of the issue date of the issued patent, the title of the issued patent, the name of an inventor of the issued patent, the home residency of an inventor of the issued patent, the serial number of the application issuing as the issued patent, the filing date of the application issuing as the issued patent, the serial number of the earliest claimed priority application of the issued patent, the filing date of the earliest claimed priority application of the issued patent, the language of a claim of the issued patent, the use or lack thereof of United States federal funding for developing the issued patent, the name of an assignee of the issued patent, the name of the examiner who examined the issued patent, the number of days of patent term adjustment available to the issued patent, the name of an attorney, agent, or firm of record for the issued patent, the presence or absence of a certificate of correction for the issued patent, the payment due dates for maintenance fees of the issued patent, and the satisfaction or lack thereof of due maintenance fees for the issued patent. The method can comprise receiving the patent number or application serial number of the issued patent, and the updated provider interface can comprise a populated field comprising the issue date of the issued patent, a populated field comprising the title of the issued patent, a populated field comprising the name of each inventor of the issued patent, and a populated field comprising the filing date of the application issuing as the issued patent. The method can comprise receiving the patent number or application serial number of the issued patent, and the updated provider interface comprises a populated field comprising the serial number of the earliest claimed priority application of the issued patent, a populated field comprising the filing date of the earliest claimed priority application of the issued patent, and a populated field comprising the name of an assignee of the issued patent. The method can comprise receiving the serial or publication number of the published patent application, and the information obtained from the public database can be selected from the group consisting of the publication date of the published patent application, the title of the published patent application, the name of an inventor of the published patent application, the home residency of an inventor of the published patent application, the serial number of the published patent application, the filing date of the published patent application, the serial number of the earliest claimed priority application of the published patent application, the filing date of the earliest claimed priority application of the published patent application, the language of a claim of the published patent application, the use or lack thereof of United States federal funding for developing the published patent application, and the name of an assignee of the published patent application. The method can comprise receiving the serial or publication number of the published patent application, and the updated provider interface can comprise a populated field comprising the publication date of the published patent application, a populated field comprising the title of the published patent application, a populated field comprising the name of each inventor of the published patent application, a populated field comprising the serial number of the published patent application, and a populated field comprising the filing date of the published patent application. The method can comprise receiving the serial or publication number of the published patent application, and the updated provider interface can comprise a populated field comprising the serial number of the earliest claimed priority application of the published patent application, a populated field comprising the filing date of the earliest claimed priority application of the published patent application, and a populated field comprising the name of an assignee of the published patent application. The provider can be asked to verify the information populated in the field. The provider can be able to change the information populated in the field. The provider interface can comprise an entry field for each characteristic of an issued patent to be entered, wherein the characteristics comprise information about the issue date of the issued patent, the title of the issued patent, the name of an inventor of the issued patent, the home residency of an inventor of the issued patent, the serial number of the application issuing as the issued patent, the filing date of the application issuing as the issued patent, the serial number of the earliest claimed priority application of the issued patent, the filing date of the earliest claimed priority application of the issued patent, the use or lack thereof of United States federal funding for developing the issued patent, the name of an assignee of the issued patent, the name of the examiner who examined the issued patent, the number of days of patent term adjustment available to the issued patent, the name of an attorney, agent, or firm of record for the issued patent, the presence or absence of a certificate of correction for the issued patent, the payment due dates for maintenance fees of the issued patent, and the satisfaction or lack thereof of due maintenance fees for the issued patent. The provider interface can comprise an entry field for each characteristic of a patent application to be entered, wherein the characteristics comprise information about the publication date, if any, of the patent application, the title of the patent application, the name of an inventor of the patent application, the home residency of an inventor of the patent application, the serial number of the patent application, the filing date of the patent application, the serial number of the earliest claimed priority application, if any, of the patent application, the filing date of the earliest claimed priority application, if any, of the patent application, the use or lack thereof of United States federal funding for developing the patent application, and the name of an assignee, if any, of the patent application. The provider interface can comprise entry fields for provider identification characteristics. The provider identification characteristics can comprise the name of the person or entity owning the intellectual property to be entered. The provider identification characteristics can comprise information selected from the group consisting of the name of the person or entity owning the intellectual property to be entered, the address of the person or entity owning the intellectual property to be entered, the phone number of the person or entity owning the intellectual property to be entered, the email address of the person or entity owning the intellectual property to be entered, and the name, address, phone number, and email address of the contact person who is an employee or agent of the person or entity owning the intellectual property to be entered. The provider interface can comprise an entry field for a provider identification number that identifies the provider as being a repeat provider. The method can comprise presenting, after receiving the provider identification number, the repeat provider with an updated provider interface comprising provider identification fields populated with information obtained from a database of prior providers. The identification fields can be populated with information selected from the group consisting of the name of the person or entity owning the intellectual property to be entered, the address of the person or entity owning the intellectual property to be entered, the phone number of the person or entity owning the intellectual property to be entered, the email address of the person or entity owning the intellectual property to be entered, and the name, address, phone number, and email address of the contact person who is an employee or agent of the person or entity owning the intellectual property to be entered. The database can comprise information about other intellectual property that has been identified as being available for sale or license and that has been entered by different providers. The provider interface can comprise an entry field for a provider-selected keyword to enhance user retrieval or evaluation of the intellectual property to be entered. The entry field for the provider-selected keyword is adapted to receive a keyword typed by the provider. The entry field for the provider-selected keyword can comprise a displayed list of keywords from which the provider can select the provider-selected keyword. The provider can select the provider-selected keyword from the displayed list. The provider interface can comprise multiple entry fields for multiple provider-selected keywords to enhance user retrieval or evaluation of the intellectual property to be entered. The provider interface can present a series of hierarchical keyword lists to be selected by the provider to enhance user retrieval or evaluation of the intellectual property to be entered. The series of hierarchical keyword lists can comprise a list of primary level keywords, secondary level keywords, and tertiary level keywords. The list of primary level keywords can comprise general subject matter area terms. The general subject matter area terms can be selected from the group consisting of software terms, computer hardware terms, network application terms, biotechnology terms, medical device terms, nanotechnology terms, chemical composition terms, and mechanical device terms. The list of secondary level keywords can comprise sub-group terms within a general subject matter area. The general subject matter area can be biotechnology, and the sub-group terms can be selected from the group consisting of research tool terms, diagnostic terms, prognostic terms, and treatment terms. The list of tertiary level keywords can comprise specific subject matter terms within a sub-group of a general subject matter area. The general subject matter area can be biotechnology, the sub-group can be cancer treatment, and the specific subject matter terms can be selected from the group consisting of breast cancer terms, colon cancer terms, brain cancer terms, lung cancer terms, skin cancer terms, and pancreatic cancer terms. The provider interface can comprise an entry field for technology development information to enhance the user's evaluation of the intellectual property to be entered. The technology development information can be selected from the group consisting of information about the existence of commercial products, the stage of development of a commercial product, the status of data obtained from in vitro or in vivo studies, the status of a pre-clinical trial, and the status of a clinical trial. The provider interface can comprise multiple entry fields for technology development information to enhance the user's evaluation of the intellectual property to be entered. The provider interface can comprise an entry field for prior art information to enhance the user's evaluation of the intellectual property to be entered. The prior art information can be selected from the group consisting of information about an inventor's prior disclosure, information about a third party's prior disclosure, information obtained via a prior art search, and information about whether or not a prior art search was conducted. The provider interface can comprise multiple entry fields for prior art information to enhance the user's evaluation of the intellectual property to be entered. The provider interface can comprise an entry field for freedom to operate information to enhance the user's evaluation of the intellectual property to be entered. The freedom to operate information can be selected from the group consisting of information about a notice received from a third party patent holder, information obtained via a freedom to operate search, and information about whether or not a freedom to operate search was conducted. The provider interface can comprise multiple entry fields for freedom to operate information to enhance the user's evaluation of the intellectual property to be entered. The intellectual property to be entered can be an issued United States patent, and the method can comprise calculating the expiration date of the issued United States patent. The method can comprise creating a record for the intellectual property to be entered, wherein the record comprises provider information and intellectual property information. The storing step can comprise storing the record. The intellectual property information can be intellectual property information provided by the provider or retrieved from a database. The record can comprise information calculated based on the intellectual property information provided by the provider or retrieved from a database. The information calculated based on the intellectual property information provided by the provider or retrieved from a database can comprise the expiration date of the intellectual property. The method can comprise providing a secure connection for the provider to enter information about intellectual property available for sale or license. The method can comprise providing the provider with the ability to edit information about the intellectual property available for sale or license, prior to the storing step. The method can comprise providing the provider with the ability to change information about the intellectual property available for sale or license, after the storing step. The method can comprise providing the provider with the ability to remove information about the intellectual property available for sale or license, prior to or after the storing step. The method can comprise providing the provider with the ability to make information about the intellectual property available for sale or license unavailable to the user. The method can comprise classifying each piece of information about the intellectual property as being (a) displayable to the user or (b) unavailable for display to the user. The method can comprise default setting for classifying each piece of information about the intellectual property as being (a) displayable to the user or (b) unavailable for display to the user. The method can comprise classifying each piece of information about the intellectual property as being (a) displayable to the user or (b) confidential, but displayable once a confidentiality agreement is signed by the user. The method can comprise providing the provider or the user with information about confidentiality agreements, licensed attorneys, and legal disclaimers regarding providing legal advice. The method can comprise presenting a record review interface for allowing the provider to review information about the intellectual property. The method can comprise presenting a portfolio management interface for allowing the provider to review information about the intellectual property in addition to other intellectual property, if any, entered by the provider. The portfolio management interface can present information about intellectual property assigned to a provider identification number used to identify the provider. The portfolio management interface can present an updateable notebook for recording information about the provider's interactions with a user interested in licensing or purchasing the intellectual property or the other intellectual property. The portfolio management interface can present a link to a separate updateable notebook for each of the provider's intellectual property presented within the portfolio management interface.

In another aspect, this document features a system comprising a server to present a provider with a provider interface for entering information about intellectual property available for sale or license, and a database for storing information about the intellectual property obtained from the provider. The provider interface can comprise an entry field for an identifying characteristic of the intellectual property to be entered. The identifying characteristic can be selected from the group consisting of a patent number, a patent application serial number, a patent application publication number, a patent title, and a patent application title. The database can receive a patent number or application serial number of an issued patent or a serial or publication number of a published patent application. The system can comprise a facilitator for accessing a public database containing the issued patent or the published patent application to obtain public information about the patent or the published patent application. The server can be capable of presenting the provider with an updated provider interface comprising a field populated with information obtained from the public database. When the database receives the patent number or application serial number of the issued patent, the information obtained from the public database can be selected from the group consisting of the issue date of the issued patent, the title of the issued patent, the name of an inventor of the issued patent, the home residency of an inventor of the issued patent, the serial number of the application issuing as the issued patent, the filing date of the application issuing as the issued patent, the serial number of the earliest claimed priority application of the issued patent, the filing date of the earliest claimed priority application of the issued patent, the language of a claim of the issued patent, the use or lack thereof of United States federal funding for developing the issued patent, the name of an assignee of the issued patent, the name of the examiner who examined the issued patent, the number of days of patent term adjustment available to the issued patent, the name of an attorney, agent, or firm of record for the issued patent, the presence or absence of a certificate of correction for the issued patent, the payment due dates for maintenance fees of the issued patent, and the satisfaction or lack thereof of due maintenance fees for the issued patent. When the database receives the patent number or application serial number of the issued patent, the updated provider interface can comprise a populated field comprising the issue date of the issued patent, a populated field comprising the title of the issued patent, a populated field comprising the name of each inventor of the issued patent, and a populated field comprising the filing date of the application issuing as the issued patent. When the database receives the patent number or application serial number of the issued patent, the updated provider interface can comprise a populated field comprising the serial number of the earliest claimed priority application of the issued patent, a populated field comprising the filing date of the earliest claimed priority application of the issued patent, and a populated field comprising the name of an assignee of the issued patent. When the database receives the serial or publication number of the published patent application, the information obtained from the public database can be selected from the group consisting of the publication date of the published patent application, the title of the published patent application, the name of an inventor of the published patent application, the home residency of an inventor of the published patent application, the serial number of the published patent application, the filing date of the published patent application, the serial number of the earliest claimed priority application of the published patent application, the filing date of the earliest claimed priority application of the published patent application, the language of a claim of the published patent application, the use or lack thereof of United States federal funding for developing the published patent application, and the name of an assignee of the published patent application. When the database receives the serial or publication number of the published patent application, the updated provider interface can comprise a populated field comprising the publication date of the published patent application, a populated field comprising the title of the published patent application, a populated field comprising the name of each inventor of the published patent application, a populated field comprising the serial number of the published patent application, and a populated field comprising the filing date of the published patent application. When the database receives the serial or publication number of the published patent application, the updated provider interface can comprise a populated field comprising the serial number of the earliest claimed priority application of the published patent application, a populated field comprising the filing date of the earliest claimed priority application of the published patent application, and a populated field comprising the name of an assignee of the published patent application. The server can be capable of sending a prompt to the provider asking the provider to verify the information populated in the field. The server can be configured to allow the provider to change the information populated in the field. The provider interface can comprise an entry field for each characteristic of an issued patent to be entered, wherein the characteristics comprise information about the issue date of the issued patent, the title of the issued patent, the name of an inventor of the issued patent, the home residency of an inventor of the issued patent, the serial number of the application issuing as the issued patent, the filing date of the application issuing as the issued patent, the serial number of the earliest claimed priority application of the issued patent, the filing date of the earliest claimed priority application of the issued patent, the use or lack thereof of United States federal funding for developing the issued patent, the name of an assignee of the issued patent, the name of the examiner who examined the issued patent, the number of days of patent term adjustment available to the issued patent, the name of an attorney, agent, or firm of record for the issued patent, the presence or absence of a certificate of correction for the issued patent, the payment due dates for maintenance fees of the issued patent, and the satisfaction or lack thereof of due maintenance fees for the issued patent. The provider interface can comprise an entry field for each characteristic of a patent application to be entered, wherein the characteristics comprise information about the publication date, if any, of the patent application, the title of the patent application, the name of an inventor of the patent application, the home residency of an inventor of the patent application, the serial number of the patent application, the filing date of the patent application, the serial number of the earliest claimed priority application, if any, of the patent application, the filing date of the earliest claimed priority application, if any, of the patent application, the use or lack thereof of United States federal funding for developing the patent application, and the name of an assignee, if any, of the patent application. The provider interface can comprise entry fields for provider identification characteristics. The provider identification characteristics can comprise the name of the person or entity owning the intellectual property to be entered. The provider identification characteristics can comprise information selected from the group consisting of the name of the person or entity owning the intellectual property to be entered, the address of the person or entity owning the intellectual property to be entered, the phone number of the person or entity owning the intellectual property to be entered, the email address of the person or entity owning the intellectual property to be entered, and the name, address, phone number, and email address of the contact person who is an employee or agent of the person or entity owning the intellectual property to be entered. The provider interface can comprise an entry field for a provider identification number that identifies the provider as being a repeat provider. The server can be configured to present, after receiving the provider identification number, the repeat provider with an updated provider interface comprising provider identification fields populated with information obtained from a database of prior providers. The identification fields can be populated with information selected from the group consisting of the name of the person or entity owning the intellectual property to be entered, the address of the person or entity owning the intellectual property to be entered, the phone number of the person or entity owning the intellectual property to be entered, the email address of the person or entity owning the intellectual property to be entered, and the name, address, phone number, and email address of the contact person who is an employee or agent of the person or entity owning the intellectual property to be entered. The database can comprise information about other intellectual property that has been identified as being available for sale or license and that has been entered by different providers. The provider interface can comprise an entry field for a provider-selected keyword to enhance user retrieval or evaluation of the intellectual property to be entered. The entry field for the provider-selected keyword can be adapted to receive a keyword typed by the provider. The entry field for the provider-selected keyword can comprise a displayed list of keywords from which the provider can select the provider-selected keyword. The provider can select the provider-selected keyword from the displayed list. The provider interface can comprise multiple entry fields for multiple provider-selected keywords to enhance user retrieval or evaluation of the intellectual property to be entered. The provider interface can be configured to present a series of hierarchical keyword lists to be selected by the provider to enhance user retrieval or evaluation of the intellectual property to be entered. The series of hierarchical keyword lists can comprise a list of primary level keywords, secondary level keywords, and tertiary level keywords. The list of primary level keywords can comprise general subject matter area terms. The general subject matter area terms can be selected from the group consisting of software terms, computer hardware terms, network application terms, biotechnology terms, medical device terms, nanotechnology terms, chemical composition terms, and mechanical device terms. The list of secondary level keywords can comprise sub-group terms within a general subject matter area. The general subject matter area can be biotechnology, and the sub-group terms can be selected from the group consisting of research tool terms, diagnostic terms, prognostic terms, and treatment terms. The list of tertiary level keywords can comprise specific subject matter terms within a sub-group of a general subject matter area. The general subject matter area can be biotechnology, the sub-group can be cancer treatment, and the specific subject matter terms can be selected from the group consisting of breast cancer terms, colon cancer terms, brain cancer terms, lung cancer terms, skin cancer terms, and pancreatic cancer terms. The provider interface can comprise an entry field for technology development information to enhance the user's evaluation of the intellectual property to be entered. The technology development information can be selected from the group consisting of information about the existence of commercial products, the stage of development of a commercial product, the status of data obtained from in vitro or in vivo studies, the status of a pre-clinical trial, and the status of a clinical trial. The provider interface can comprise multiple entry fields for technology development information to enhance the user's evaluation of the intellectual property to be entered. The provider interface can comprise an entry field for prior art information to enhance the user's evaluation of the intellectual property to be entered. The prior art information can be selected from the group consisting of information about an inventor's prior disclosure, information about a third party's prior disclosure, information obtained via a prior art search, and information about whether or not a prior art search was conducted. The provider interface can comprise multiple entry fields for prior art information to enhance the user's evaluation of the intellectual property to be entered. The provider interface can comprise an entry field for freedom to operate information to enhance the user's evaluation of the intellectual property to be entered. The freedom to operate information can be selected from the group consisting of information about a notice received from a third party patent holder, information obtained via a freedom to operate search, and information about whether or not a freedom to operate search was conducted. The provider interface can comprise multiple entry fields for freedom to operate information to enhance the user's evaluation of the intellectual property to be entered. The intellectual property to be entered can be an issued United States patent, and the system can comprise calculator module for calculating the expiration date of the issued United States patent. The database can be configured to create a record for the intellectual property to be entered, wherein the record comprises provider information and intellectual property information. The database can store the record. The intellectual property information can be intellectual property information provided by the provider or retrieved from a public database. The record can comprise information calculated based on the intellectual property information provided by the provider or retrieved from a public database. The information calculated based on the intellectual property information provided by the provider or retrieved from a public database can comprise the expiration date of the intellectual property. The system can provide a secure connection to allow the provider to enter information about intellectual property available for sale or license. The system can be capable of providing the provider with the ability to edit information about the intellectual property available for sale or license, prior to storing the information in the database. The system can be capable of providing the provider with the ability to change information about the intellectual property available for sale or license, after storing the information in the database. The system can be capable of providing the provider with the ability to remove information about the intellectual property available for sale or license, prior to or after storing the information in the database. The system can be capable of providing the provider with the ability to make information about the intellectual property available for sale or license unavailable to a user. Each piece of information about the intellectual property can be classified as being (a) displayable to a user or (b) unavailable for display to a user. The system can be capable of classifying, by default, each piece of information about the intellectual property as being (a) displayable to a user or (b) unavailable for display to a user. Each piece of information about the intellectual property can be classified as being (a) displayable to a user or (b) confidential, but displayable once a confidentiality agreement is signed by a user. The system can be capable of providing the provider or a user with information about confidentiality agreements, licensed attorneys, and legal disclaimers regarding providing legal advice. The server can be capable of presenting a record review interface for allowing the provider to review information about the intellectual property. The server can be capable of providing a portfolio management interface for allowing the provider to review information about the intellectual property in addition to other intellectual property, if any, entered by the provider. The portfolio management interface can be capable of presenting information about intellectual property assigned to a provider identification number used to identify the provider. The portfolio management interface can be capable of presenting an updateable notebook for recording information about the provider's interactions with a user interested in licensing or purchasing the intellectual property or the other intellectual property. The portfolio management interface can be capable of presenting a link to a separate updateable notebook for each of the provider's intellectual property presented within the portfolio management interface.

In another aspect, this document features a method for retrieving intellectual property information from a database of available intellectual property. The method comprises:

(a) presenting a user with a user interface for entering search information,

(b) receiving the search information entered into the user interface by the user,

(c) searching a database for records matching the search information, wherein the database comprises intellectual property records for intellectual property identified as being available for sale or licensing, wherein each intellectual property record of the database was entered by a provider of the intellectual property, and

(d) presenting the user with search result output comprising either (i) an indication of no matching records or (ii) information obtained from one or more records of the database. The user can be an owner or employee of a biotechnology investment company. The user can be a venture capitalist. The search information can comprise information selected from the group consisting of the name of an owner of intellectual property, the name of an inventor of intellectual property, a patent number, a patent publication number, a patent application serial number, information about the subject matter of intellectual property, keywords describing intellectual property, information about the existence of a commercial product, information about the stage of development of a commercial product, information about the status of data obtained from in vitro or in vivo studies, information about the status of a pre-clinical trial, and information about the status of a clinical trial. The method can comprise authenticating the identity of the user. The method can comprise charging the user a fee before or after the step (d). The search result output can comprise information obtained from two or more records. The method can comprise ranking the information of the search result output based on the search information. The search result output can comprise an intellectual property rank for each intellectual property of the search result output. The search result output can comprise a provider score for each provider or listed owner of each intellectual property of the search result output. The search result output can comprise an inventor score for each named inventor of each intellectual property of the search result output. A parser can be used to parse the search information. A compiler can be used to compile the search result output.

In another aspect, this document features a system comprising a server to present a user with a user interface for entering search information to locate a record of intellectual property available for sale or license, and a database containing a plurality of records containing information about intellectual property identified as being available for sale or license, wherein the information was obtained from a provider of the intellectual property. The user interface can comprise an entry field for an identifying characteristic of intellectual property of interest to the user. The identifying characteristic can be selected from the group consisting of a patent number, a patent application serial number, a patent application publication number, a patent title, and a patent application title. The user interface can comprise an entry field for a provider identification characteristic of intellectual property of interest to the user. The provider identification characteristic can be the name of a person or entity owning the intellectual property of interest to the user. The user interface can comprise an entry field for a user-selected keyword to aid in the retrieval or evaluation of intellectual property of interest to the user. The entry field for the user-selected keyword can be adapted to receive a keyword typed by the user. The entry field for the user-selected keyword can comprise a displayed list of keywords from which the user can select the user-selected keyword. The user interface can comprise multiple entry fields for multiple user-selected keywords to aid in the retrieval or evaluation of intellectual property of interest to the user. The user interface can comprise a series of hierarchical keyword lists to be selected by the user to aid in the retrieval or evaluation of intellectual property of interest to the user. The series of hierarchical keyword lists can comprise a list of primary level keywords, secondary level keywords, and tertiary level keywords. The list of primary level keywords can comprise general subject matter area terms. The general subject matter area terms can be selected from the group consisting of software terms, computer hardware terms, network application terms, biotechnology terms, medical device terms, nanotechnology terms, chemical composition terms, and mechanical device terms. The list of secondary level keywords can comprise sub-group terms within a general subject matter area. The general subject matter area can be biotechnology, and the sub-group terms can be selected from the group consisting of research tool terms, diagnostic terms, prognostic terms, and treatment terms. The list of tertiary level keywords can comprise specific subject matter terms within a sub-group of a general subject matter area. The general subject matter area can be biotechnology, the sub-group can be cancer treatment, and the specific subject matter terms can be selected from the group consisting of breast cancer terms, colon cancer terms, brain cancer terms, lung cancer terms, skin cancer terms, and pancreatic cancer terms. The user interface can comprise an entry field for technology development information to aid in the retrieval or evaluation of intellectual property of interest to the user. The technology development information can be selected from the group consisting of information about the existence of commercial products, the stage of development of a commercial product, the status of data obtained from in vitro or in vivo studies, the status of a pre-clinical trial, and the status of a clinical trial. The user interface can comprise multiple entry fields for technology development information to aid in the retrieval or evaluation of intellectual property of interest to the user. The user interface can comprise an entry field for prior art information to aid in the retrieval or evaluation of intellectual property of interest to the user. The prior art information can be selected from the group consisting of information about an inventor's prior disclosure, information about a third party's prior disclosure, information obtained via a prior art search, and information about whether or not a prior art search was completed. The user interface can comprise multiple entry fields for prior art information to aid in the retrieval or evaluation of intellectual property of interest to the user. The user interface can comprise an entry field for freedom to operate information to aid in the retrieval or evaluation of intellectual property of interest to the user. The freedom to operate information can be selected from the group consisting of information about a notice received from a third party patent holder, information obtained via a freedom to operate search, and information about whether or not a freedom to operate search was completed. The user interface can comprise multiple entry fields for freedom to operate information to aid in the retrieval or evaluation of intellectual property of interest to the user. The system can comprise a security module for providing a secure connection to allow the user to enter information about intellectual property of interest to the user. The server can be capable of presenting a record review interface for allowing the user to review information about intellectual property. The server can be capable of presenting a candidate management interface for allowing the user to review information about one or more user-selected intellectual property records. The candidate management interface can present information about user-selected intellectual property assigned to a user identification number used to identify the user. The candidate management interface can present an updateable notebook for recording information about the user's interactions with a provider interested in licensing or selling intellectual property. The candidate management interface can present a link to a separate updateable notebook for each user-selected intellectual property record. The system can comprise an authenticator for authenticating the identity of the user. The system can comprise a bill module for charging the user a fee. The server can be capable of presenting search result output to the user, or the system can comprise a second server that is capable of presenting search result output to the user. The search result output can comprise information obtained from two or more records of the database. The system can comprise a ranker configured to rank information of the search result output based on the search information. The system can comprise an intellectual property ranker configured to rank intellectual property of the search result output based on the search information. The system can comprise a provider scorer configured to score a provider or owner of intellectual property of a record of intellectual property. The system can comprise an inventor scorer configured to score a named inventor of intellectual property of a record of intellectual property. The system can comprise a parser to parse the search information. The system can comprise a compiler to compile search result output.

In another aspect, this document features a method for facilitating transfer of intellectual property rights. The method comprises:

(a) presenting providers with a provider interface for entering information about each provider's intellectual property available for sale or license,

(b) receiving information entered into the provider interface by each of the providers,

(c) storing the received information of step (b) in a database as an intellectual property record, wherein each provider's intellectual property forms a separate intellectual property record within the database,

(d) presenting a user with a user interface for entering search information,

(e) receiving the search information entered into the user interface by the user,

(f) searching the database for intellectual property records matching the search information, and

(g) presenting the user with search result output comprising information about any records within the database matching the search information.

In another aspect, this document features a system comprising:

a server to present (a) providers with a provider interface for entering information about intellectual property available for sale or license so that each of the providers can create an intellectual property record and (b) users with a user interface for entering search information to locate an intellectual property record, and a database for storing each intellectual property record and for searching each intellectual property record for information that matches the search information. The system can comprise a parser to parse information provided by the provider into components of the intellectual property record. The system can comprise a compiler to compile information from an intellectual property record located by the user for presentation to the user.

In another aspect, this document features a method for entering intellectual property information into a database of available intellectual property. The method comprises:

(a) receiving information entered into a provider interface by a provider, wherein the received information comprises provider identification information and information about an identifying characteristic of intellectual property available for sale or license,

(b) parsing the received information into components of a database record, wherein a component of the database record comprises an entry based on the provider identification information, and wherein another component of the database record comprises an entry based on the information about an identifying characteristic of intellectual property available for sale or license, and

(c) storing the database record in a database for retrieval by a user. The received information can comprise technology development information. The received information can comprise information about a provider-selected keyword.

In another aspect, this document features a method for facilitating transfer of intellectual property rights. The method comprises:

(a) presenting providers with the ability to access a provider interface for entering information about each provider's intellectual property available for sale or license,

(b) receiving information entered into the provider interface by each of the providers,

(c) parsing the received information of step (b) for each of the providers into components of an intellectual property record, wherein each provider's intellectual property forms a separate intellectual property record,

(d) storing each provider's intellectual property record in a database,

(e) presenting a user with the ability to access a user interface for entering search information,

(f) receiving the search information entered into the user interface by the user,

(g) searching the database for intellectual property records matching the search information, and

(h) presenting the user with the ability to access search result output comprising information about any records within the database matching the search information.

In another aspect, this document features a system comprising:

a server to provide (a) providers with the ability to access a provider interface for entering information about intellectual property available for sale or license so that each of the providers can create an intellectual property record and (b) users with the ability to access a user interface for entering search information to locate an intellectual property record,

a parser to parse the information about intellectual property available for sale or license into a format to create an intellectual property record for each of the provider's intellectual property, and

a database for storing each intellectual property record and for searching each intellectual property record for information that matches the search information. The system can comprise a search module to receive information from the user interface and search the database for a matching intellectual property record. The system can comprise a compiler to compile search result output for presentation to the user.

Unless otherwise defined, all technical and scientific terms used herein have the same meaning as commonly understood by one of ordinary skill in the art to which this document pertains. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

Other features and advantages of the invention will be apparent from the following detailed description, and from the claims.

### DESCRIPTION OF THE DRAWINGS

FIG. 1 is a diagram of an exemplary embodiment of a system designed to facilitate interactions between a provider of intellectual property and a user interested in purchasing or licensing intellectual property.

FIG. 2 is a chart of items capable of being presented to a provider of intellectual property available for sale or license.

FIG. 3 is an outline listing the general hierarchical structure of a list of keywords for intellectual property in the biotechnology field.

FIG. 4 is a chart of items capable of being presented to a user interested in purchasing or licensing intellectual property available for sale or license.

### DETAILED DESCRIPTION

This document provides systems and methods for entering and retrieving data. For example, this document relates to systems and methods that can allow providers to enter information about available (e.g., assignable or licensable) intellectual property into a searchable database accessible to users having an interest in buying or licensing intellectual property. A provider can be the sole owner of intellectual property, a co-owner of intellectual property, or an employee or agent of a sole or co-owner of intellectual property. For example, a provider can be a technology transfer office employee of a university that owns intellectual property. In general, the term “intellectual property” as used herein refers to patents and patent applications. Examples of intellectual property include, without limitation, the subject matter of an issued United States utility, plant, or design patent, a granted non-United States (e.g., European, Canadian, Australian, Japanese, or Chinese) patent, a pending United States provisional patent application, a pending United States utility, plant, or design patent application, and a pending non-United States (e.g., European, Canadian, Australian, Japanese, or Chinese) patent application. In some cases, intellectual property can be know-how, a trade secret, or a copyright.

In general, the systems and methods provided herein can be allow a provider to enter available intellectual property into a searchable database that is accessible to a user interested in purchasing or licensing intellectual property. Such a user can be an investor, an employee of an investment company, or a venture capitalist. Other examples of users include, without limitation, any individual or employee of a company interested in purchasing or licensing intellectual property.

The systems and methods provided herein can be configured such that a provider can quickly enter intellectual property records into a database. For example, a system or method provided herein can be configured such that when a provider enters a patent number, patent publication number, or patent application number, other information about that intellectual property is populated into on-screen fields for the provider's verification. Public databases such as the U.S. Patent and Trademark Office's patent database can be accessed or used to obtain public information about the intellectual property for inclusion in the provider's intellectual property record. For example, once a provider enters a patent number or patent application publication number, the systems and methods provided herein can obtain public information such as the issue date of the patent, the title of the patent, the name of the inventor(s) of the patent, the home residency of the inventor(s) of the patent, the serial number of the application issuing as the patent, the filing date of the application issuing as the patent, the serial number of the earliest claimed priority application of the patent, the filing date of the earliest claimed priority application of the patent, the language of a claim of the patent (e.g., claim 1 or all independent claims), the use or lack thereof of United States federal funding for developing the patent, the name of an assignee of the patent, the name of the examiner who examined the patent, the number of days of patent term adjustment available to the patent, the name of an attorney, agent, or firm of record for the patent, the presence or absence of a certificate of correction for the patent, the payment due dates for maintenance fees of the patent, the satisfaction or lack thereof of due maintenance fees for the patent, the publication date of the published patent application, the title of the published patent application, the name of the inventor(s) of the published patent application, the home residency of the inventor(s) of the published patent application, the serial number of the published patent application, the filing date of the published patent application, the serial number of the earliest claimed priority application of the published patent application, the filing date of the earliest claimed priority application of the published patent application, the language of a claim of the published patent application (e.g., claim 1 or all independent claims), the use or lack thereof of United States federal funding for developing the published patent application, and the name of an assignee of the published patent application. If the populated information is accurate, the provider can accept the populated information. If the populated information is inaccurate or not complete, the provider can change or supplement the populated information.

In some cases, the systems and methods provided herein can be configured allow a provider to enter additional information about the intellectual property available of sale or license. Such additional information can include, without limitation, information designed to aid a potential user in retrieving and evaluating intellectual property of interest to the potential user such as keyword information, information about technology development, information about prior art, information about freedom to operate, and information about patent prosecution history. For example, the systems and methods provided herein can be configured to allow a provider to enter one or more keywords of the provider's choice. In some cases, the systems and methods provided herein can be configured such that the provider can select one or a series of keywords from a pre-defined list of keywords. Such pre-defined lists of keywords can be divided into different technology areas and into different levels of specificity. For example, the systems and methods provided herein can be configured to present a list of general technology areas such as biotechnology, medical devices, software, computer components, industrial products, and automotive components. The systems and methods provided herein can be configured such that when a provider selects a general technology area, a new list of more specific terms within that general technology area can be presented to the provider for selection. In the case of biotechnology, a new list can include items such as treatments, diagnostics, prognostics, and research tools. A further list can be presented based on a provider's selection from the previous list. For example, a provider selecting treatments can be presented with a list of general diseases or conditions (e.g., cancer, inflammatory conditions, autoimmune conditions, or dementia conditions). Such levels of increasing specificity can continue for multiple rounds (e.g., two, three four, five, six, seven, eight, nine, ten, or more rounds).

Information about technology development can include, without limitation, information about the existence of one or more commercial products, the stage of development of one or more commercial products, the status of data obtained from in vitro or in vivo studies, the status of a pre-clinical trial, and the status of a clinical trial.

For example, a provider of intellectual property available of sale or license can enter information about the presence or absence of an FDA clinical trial.

Information about prior art (or other material information) can include, without limitation, information about identified prior art, information about the performance of an invention, an inventor's prior art, and information about whether or not a prior art search has been conducted. For example, a provider can enter information about the degree of prior art searching performed (e.g., no, little, moderate, or extensive prior art searching).

Information about freedom to operate can include, without limitation, information about identified third party patents or patent applications, information about notice received from a third party patent holder, and information about whether or not a freedom to operate search has been conducted. For example, a provider can enter information about the degree of freedom to operate searching performed (e.g., no, little, moderate, or extensive freedom to operate searching).

Information about patent prosecution history can include, without limitation, information about whether or not an office action was received, the number of office actions received, whether or not a claim amendment was filed, the number of claim amendments filed, whether or not an appeal brief was filed, whether or not an examiner's answer was received, whether or not a reply to an examiner's answer was filed, whether or not an oral argument was presented to the appeals board, whether or not an appeal board decision was received, whether or not a request for continuing examination was filed, the identity of any rejections of record at any point during prosecution (e.g., anticipation, obviousness, lack of utility, lack of written description, lack of enablement, new matter, double patenting), the identity of any outstanding rejections (e.g., anticipation, obviousness, lack of utility, lack of written description, lack of enablement, new matter, double patenting), whether or not a terminal disclaimer was filed, whether or not a declaration under 37 C.F.R. §1.131 or §1.132 was filed, whether or not a notice of abandonment was received, whether or not a petition to revive was filed, and whether or not a petition to change inventorship was filed. For example, a provider can enter information about how the first filed patent application receiving a first action notice of allowance.

The systems and methods provided herein can be configured such that a provider can decide whether or not to restrict access to certain information entered by the provider. For example, the systems and methods provided herein can be configured such that a provider can restrict access to prior art and freedom to operate information while allowing users to have access to prosecution history information. Any of the information entered by a provider can be designated as being restricted. In addition, the level of restriction can vary and can be set by a provider. For example, certain information can be completely restricted, while other information can be designated as being restricted until a confidentiality agreement is obtained from the user interested in the information. In some cases, the systems and methods provided herein can be configured to have a default setting for each entry field. For example, all the information entered by a provider can be unrestricted to all users. In some cases, default settings can set certain provider information as being restricted and other provider information as being unrestricted.

In some embodiments, the systems and methods provided herein can provide users with the ability to search for specific intellectual property opportunities in a quick and efficient manner. For example, a system or method provided herein can be configured such that a user can enter search information that allows the user to obtain a meaningful list of intellectual property available for purchase or license. Such search information can be any of the information received from a provider of intellectual property available for sale or license. For example, such information can include, without limitation, user-selected keywords, technology development information (e.g., a user's preferred stage of commercial development such as not started or early, intermediate, or late stage development), prior art information (e.g., a user's preferred level of completed prior art searching such as little, moderate, or extensive searching), and freedom to operate information (e.g., a user's preferred level of completed freedom to operate searching such as little, moderate, or extensive searching).

Any configuration can be used to allow a provider to enter information about intellectual property into a database of intellectual property records and/or to allow a user to search for intellectual property of interest. For example, a computer network, intranet system, or internet system can be used to provide providers access to entry fields for entering information about intellectual property and/or to provide users access to search abilities capable of identifying intellectual property of interest. Typically, a web-based system is used to allow a provider to access and enter information into a database of intellectual property records. A web-based system also can be used to allow a user to access and enter search information for retrieving information from a database of intellectual property records. For example, a server can be used to present a provider or user with one or more web pages having data entry fields designed to receive information from the provider or user. In some cases, a provider or user can be required to sign-in or undergo a verification of identity before being given access to the data entry fields. For example, an authenticator can be used to confirm the identity of a previous provider or user or to verify that a particular, new provider or user is who he or she claims to be. In some cases, an authenticator can be designed (1) to process provider identification numbers and/or passwords or user identification numbers and/or passwords, or (2) to generate and send e-mail to a new provider or user to verify identity. In some cases, an authenticator can be designed to verify identity though addresses, billing information, or phone numbers. Once given access, a provider can enter information about the intellectual property available of sale or license, and a user can enter search information to help the user identify meaningful intellectual property. In some cases, a parser can be used to parse information entered by a provider into components of an intellectual property record for, for example, storage in a database. In some cases, a parser can be used to parse search information entered by a user into components for searching intellectual property records in a database.

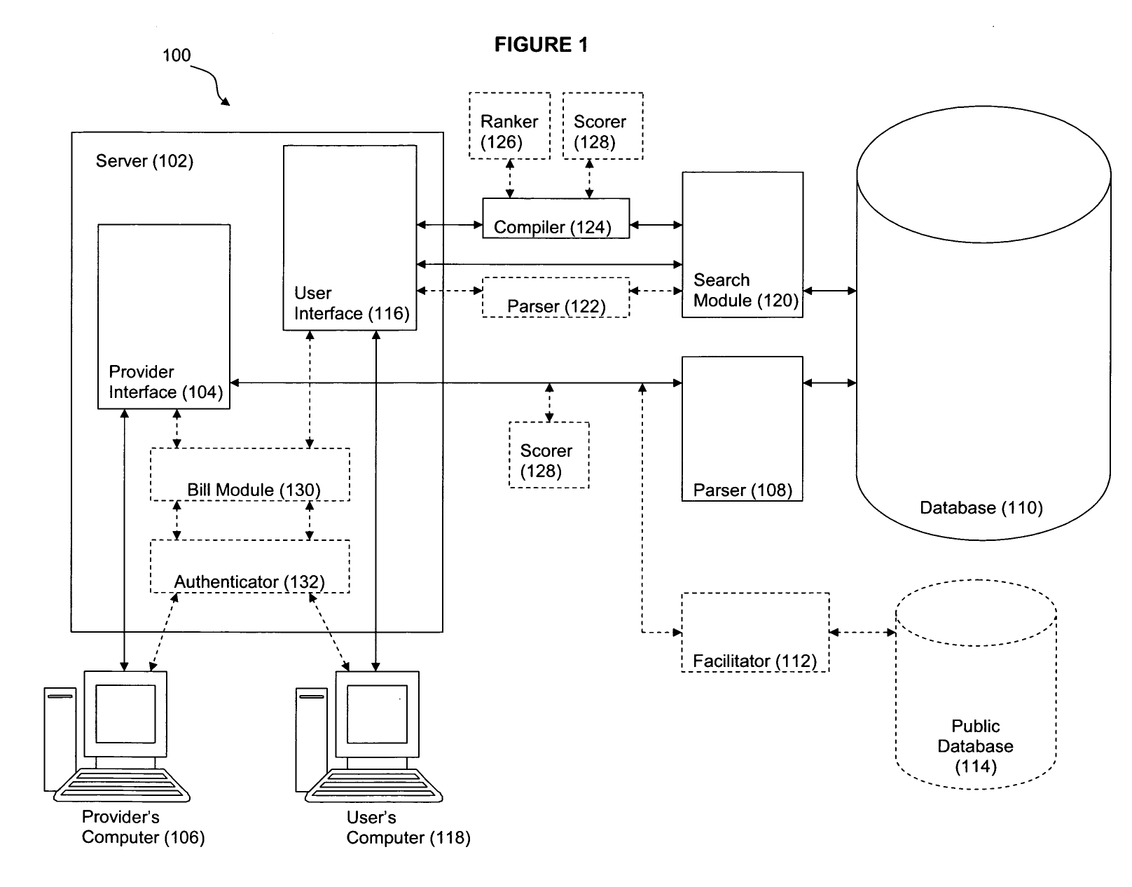

In reference to FIG.1, system 100 can have server 102. In some case, a system provided herein can have multiple servers. Server 102 can be configured to have provider interface 104, which can be presented to a provider. For example, server 102 can be configured to enable a provider to use provider's computer 106 to enter information via provider interface 104. Once information is received via provider interface 104, parser 108 can parse the received information into components of an intellectual property record, which can be stored in database 110. In some cases, multiple parsers and/or multiple databases can be used.

In some cases, facilitator 112 can be used to facilitate the addition of information into a provider's intellectual property record by, for example, accessing public database 114. Public database 114 can be any patent or patent application database including, without limitation, United States Patent & Trademark Office databases, European Patent Office database, and Japanese Patent Office database. Information obtained from public database 114 can be presented to a provider via an updated provider interface. A provider can change, edit, add to, or delete the information of an updated provider interface.

In some cases, server 102 (or a separate server of system 100) can be configured to have user interface 116, which can be presented to a user. For example, server 102 can be configured to enable a user to use user's computer 118 to enter information via user interface 116. Once information is received via user interface 116, parser 112 can parse the received information into components so that search module 120 can retrieve intellectual property records from database 110. In some cases, search module 120 can retrieve intellectual property records from database 110 without being parsed via parser 122. In some systems, parser 108 and parser 122 can be the same. Compiler 124 can be used to compile information from retrieved intellectual property records into any type of format for presentation to the user. In some cases, compiler 124 can be set to provide a particular user with retrieved information in a format selected by that user.

System 100 can have ranker 126. Ranker 126 can be configured to rank retrieved intellectual property records based on, for example, a user's search information. Once ranked, compiler 124 can compile retrieved intellectual property records in an order set by ranker 126. For example, a retrieved intellectual property record with a high number of matches with a user's search information can be ranked higher than a retrieved intellectual property record with a lower number of matches, and the higher ranked intellectual property record can be presented to the user before (or higher on a list than) the lower ranked intellectual property record.

System 100 can have scorer 128. Scorer 128 can be configured to score particular information about a provider's intellectual property. For example, scorer 128 can provide a provider score or an inventor score. A provider score can be a rating of a provider of intellectual property available for sale or license. Such a rating can be from a scale (e.g., a 1 to 10 scale or a 1 to 100 scale), and can be based on information about the provider such as the number of patent applications filed by the provider, the number of patents issued to the provider, the number of licensing agreements executed, the annual revenue resulting from licensing efforts, the number of employees, the number of commercialized products, the market capitalization of the provider, the number of lawsuits naming the provider as a party (e.g., a defendant or a plaintiff in a patent litigation), and the number of transactions completed using a system or method provided herein. For example, a provider with (1) a large number of patents and patent applications entered into a system provided herein, (2) a larger number of prior patent licensing agreements, (3) large annual revenue resulting from licensing efforts, (4) many employees, (5) many commercialized products, (6) a large market capitalization, (7) no lawsuits, and (8) a large number of transactions completed using a system provided herein can be assigned a higher score than another provider with (1) a small number of patents and patent applications entered into a system provided herein, (2) few prior patent licensing agreements, (3) minimal annual revenue resulting from licensing efforts, (4) few employees, (5) no commercialized products, (6) a small market capitalization, (7) many patent lawsuits, and (8) no transactions completed using a system provided herein.

A provider score can be used to aid a user in deciding how and whether to proceed with a transaction with a particular provider. For example, a user can avoid providers with a low provider score and can focus licensing possibilities with providers having a high provider score. In some cases, a high number can represent a good provider score, and a low number can represent a poor provider score. In other cases, a low number can represent a good provider score, and a high number can represent a poor provider score.

The systems and methods provided herein can be configured to present a provider with a provider interface for entering information used to establish a provider score. Such information includes, without limitation, information about the number of patent applications filed by the provider, the number of patents issued to the provider, the number of licensing agreements executed, the annual revenue resulting from licensing efforts, the number of employees, the number of commercialized products, the market capitalization of the provider, the number of lawsuits naming the provider as a party (e.g., a defendant or a plaintiff in a patent litigation), whether or not the provider is located within the United States, and the number of transactions completed using a system or method provided herein.

An inventor score can be a rating of an inventor of intellectual property available for sale or license. Such a rating can be from a scale (e.g., a 1 to 10 scale or a 1 to 100 scale), and can be based on information about the inventor such as the number of patent applications filed in the inventor's name, the number of patents issued with the inventor's name, the number of licensed patents or patent applications with the inventor's name, the number of scientific publications (e.g., peer-reviewed publications) by the inventor, the number of grants (e.g., National Institutes of Health (NIH) or National Science Foundation (NSF) grants) received by the inventor, and the name and reputation of the inventor's employer (e.g., the name and reputation of the college, university, or research institution where the inventor works, if applicable). For example, an inventor, who is a professor at a prestigious university, with (1) many patent applications filed in the inventor's name, (2) many patents issued with the inventor's name, (3) many licensed patents or patent applications with the inventor's name, (4) many scientific publications in peer-reviewed journals, and (5) a large number or dollar value of NIH grants can be assigned a higher score than another inventor, who is a professor at a small, not well known university, with (1) few patent applications filed in the inventor's name, (2) few patents issued with the inventor's name, (3) few licensed patents or patent applications with the inventor's name, (4) few scientific publications in peer-reviewed journals, and (5) a small number or dollar value of NIH grants.

An inventor score can be used to aid a user in deciding how and whether to proceed with a transaction regarding intellectual property naming that particular inventor. For example, a user can avoid intellectual property associated with a low inventor score and can focus licensing possibilities on intellectual property associated with a high inventor score. In some cases, a high number can represent a good inventor score, and a low number can represent a poor inventor score. In other cases, a low number can represent a good inventor score, and a high number can represent a poor inventor score.

The systems and methods provided herein can be configured to present a provider with a provider interface for entering information used to establish an inventor score. Such information includes, without limitation, information about the inventor such as the number of patent applications filed in the inventor's name, the number of patents issued with the inventor's name, the number of licensed patents or patent applications with the inventor's name, whether or not the inventor is located within the United States, the number of scientific publications (e.g., peer-reviewed publications) by the inventor, the number of grants (e.g., NIH or NSF grants) received by the inventor, and the name and reputation of the inventor's employer (e.g., the name and reputation of the college, university, or research institution where the inventor works, if applicable).

In some cases, a facilitator can be used to facilitate the addition of information related to a provider or an inventor by, for example, accessing one or more public databases (e.g., United States Patent & Trademark Office databases, European Patent Office database, Japanese Patent Office database, and/or Medline databases) or online search engines. Information obtained from a public database or online search engine can be presented to a provider via an updated provider interface, and the provider can change, edit, add to, or delete the information of the updated provider interface. In some cases, a provider score or an inventor score can be calculated using a scoring or evaluation service or system such as those provided by Index Copernicus International (world wide web at “indexcopernicus.com”) or similar companies.

With further reference to FIG. 1, system 100 can include bill module 130 and/or authenticator 132. Bill module 130 can be configured to bill providers and users. In some cases, bill module can track fees to be charged to a particular provider or user, send an invoice to the particular provider or user, and collect payment of the invoice. Authenticator 132 can be configured to verify the identity of a provider or user. For example, authenticator 132 can be used to confirm the identity of a previous provider or user or to verify that a particular, new provider or user is who he or she claims to be. In some cases, authenticator 132 can be designed (1) to process provider identification numbers and/or passwords or user identification numbers and/or passwords, or (2) to generate and send e-mail to a new provider or user to verify identity. In some cases, authenticator 132 can be designed to verify identity though addresses, billing information, or phone numbers.

The systems and methods provided herein can be configured to present providers with a record review interface such that a provider can review and edit, if necessary, the information used to generate an intellectual property record prior to making that record available to users. Such a record review interface can be configured to present the provider with a representation of what users will see when accessing the provider's record.

The systems and methods provided herein can be configured to present providers with a portfolio management interface such that a provider can conveniently view and track all the intellectual property records (or a provider-selected subset thereof) entered by that provider. Such a portfolio management interface can be configured to allow a provider to track progress with users for each intellectual property record. For example, each intellectual property record of a portfolio management interface can have a notebook (e.g., updateable electronic notebook) associated with it so that a provider can enter comments or remarks specific for each particular intellectual property record. In some cases, a system or method provided herein can be configured such that a user can send a communication (e.g., an email-like communication) to a provider in a way that automatically inserts the communication into a notebook associated with the proper intellectual property record for which the communication pertains. Such a system or method can be configured to send a regular e-mail or similar communication notifying the provider of receipt of a communication from a user.

The systems and methods provided herein can be configured to present users with a candidate management interface such that a user can conveniently view and track all retrieved intellectual property records (or a user-selected subset thereof). Such a candidate management interface can be configured to allow a user to track progress with providers for each intellectual property record. For example, each intellectual property record of a candidate management interface can have a notebook (e.g., updateable electronic notebook) associated with it so that a user can enter comments or remarks specific for each particular intellectual property record. In some cases, a system or method provided herein can be configured such that a provider can send a communication (e.g., an email-like communication) to a user in a way that automatically inserts the communication into a notebook associated with the proper intellectual property record for which the communication pertains. Such a system or method can be configured to send a regular e-mail or similar communication notifying the user of receipt of a communication from a provider.

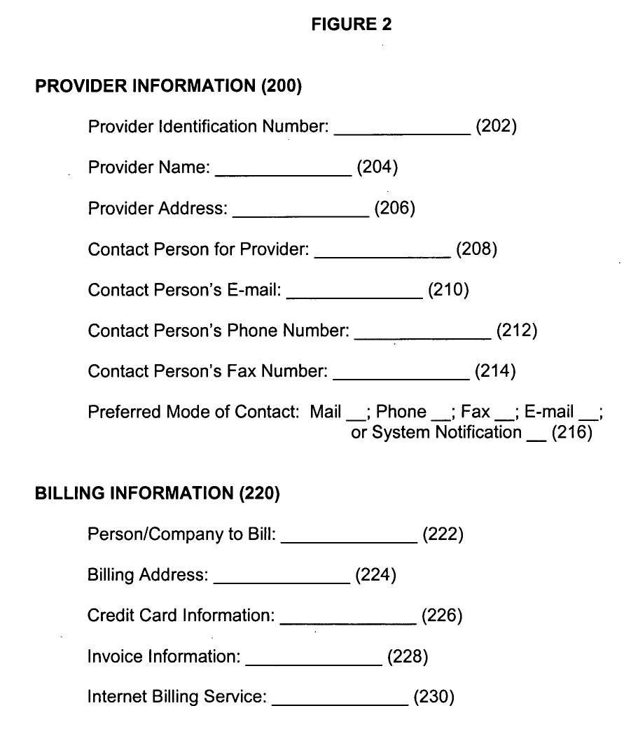

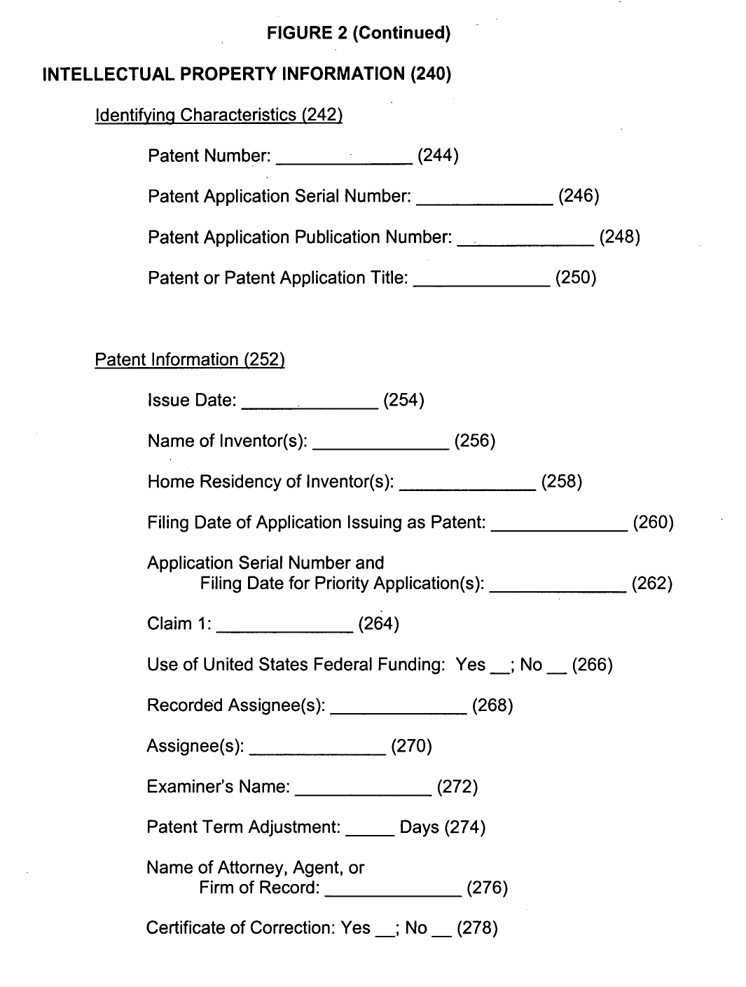

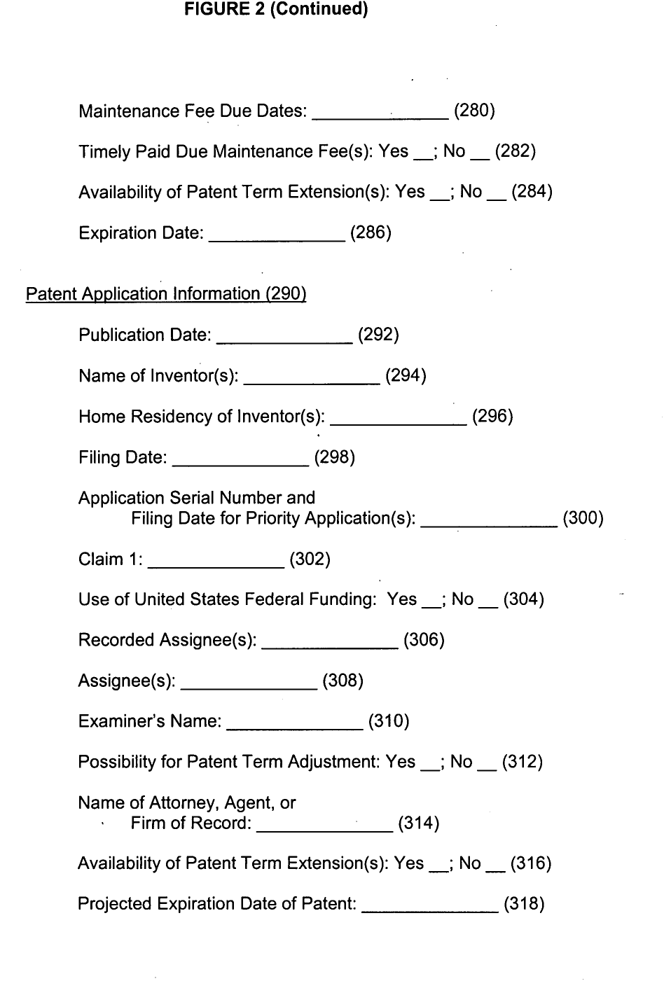

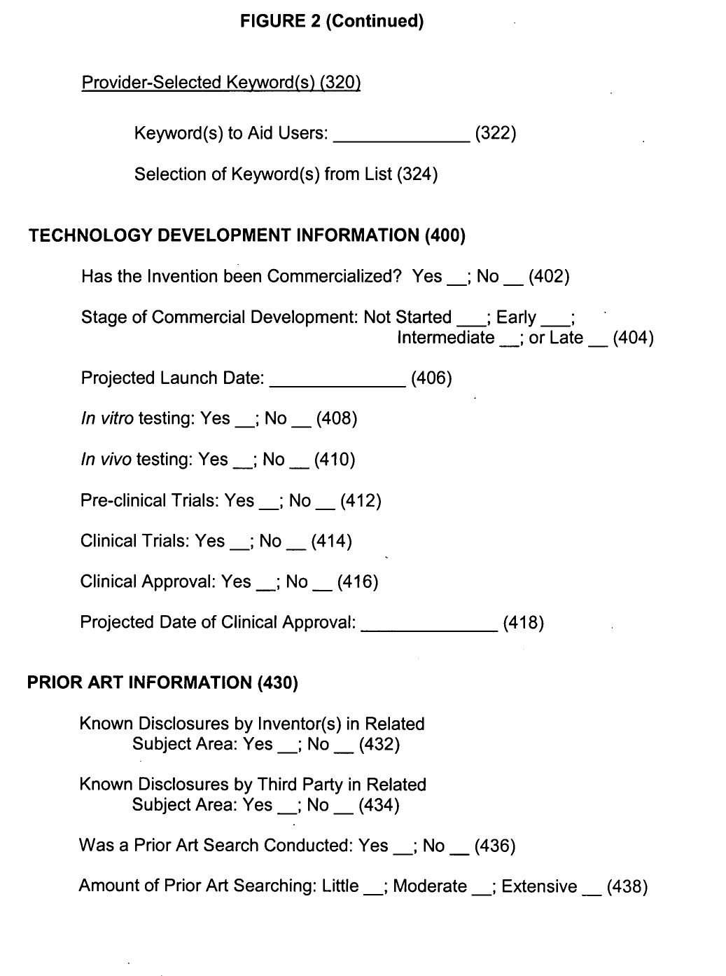

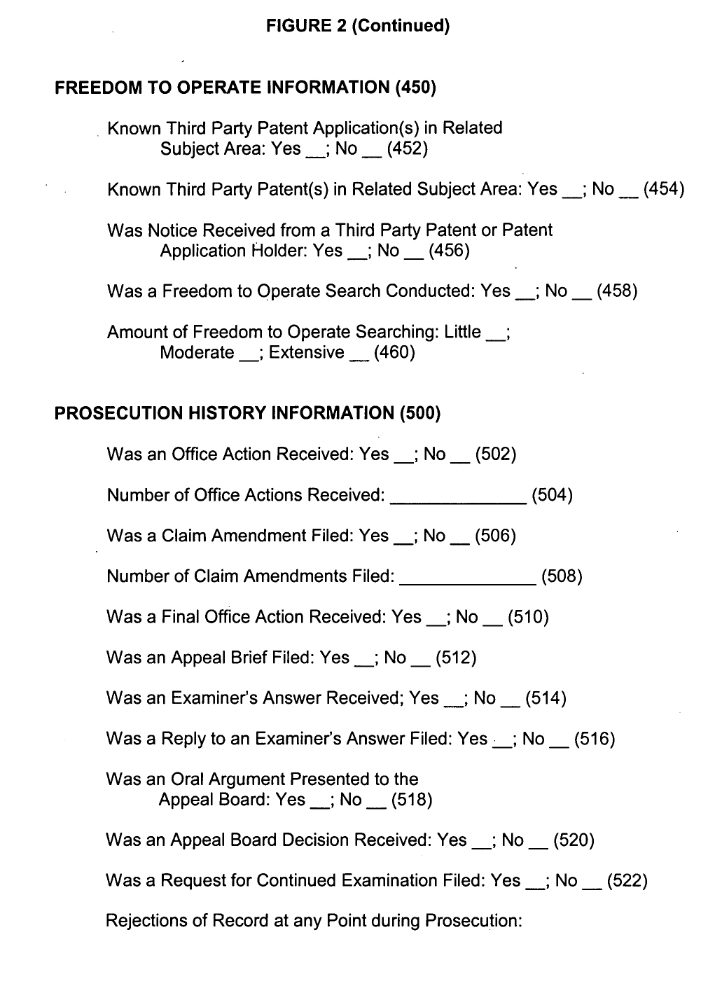

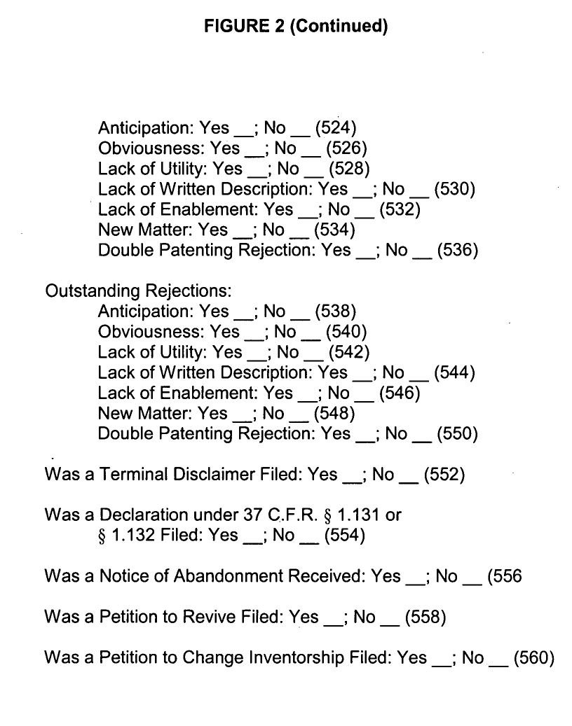

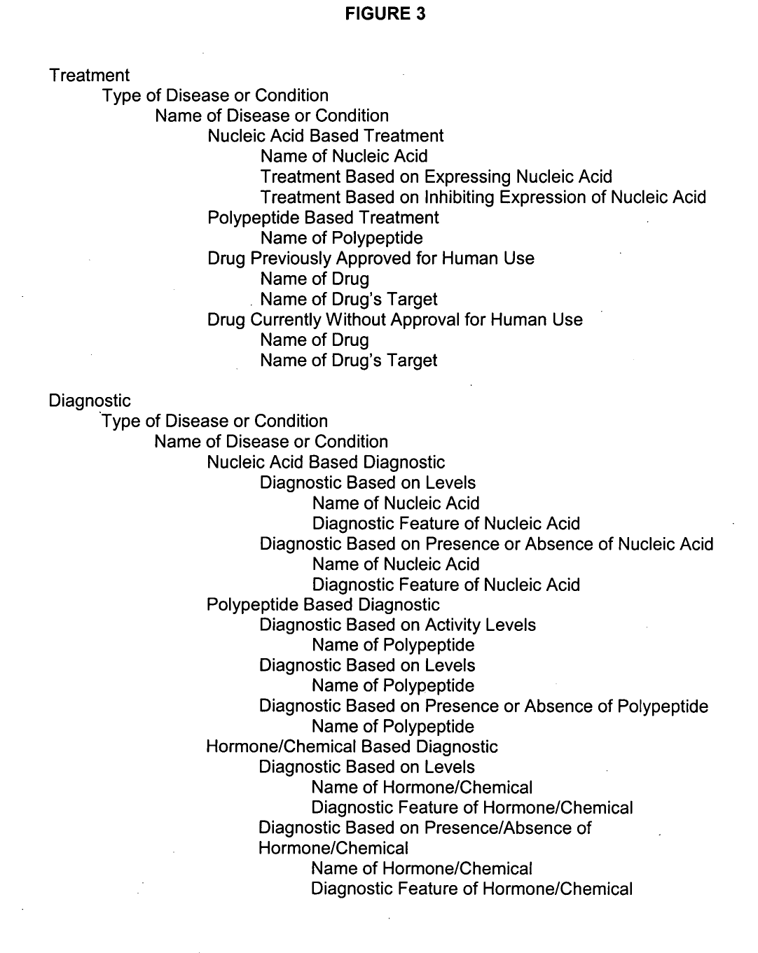

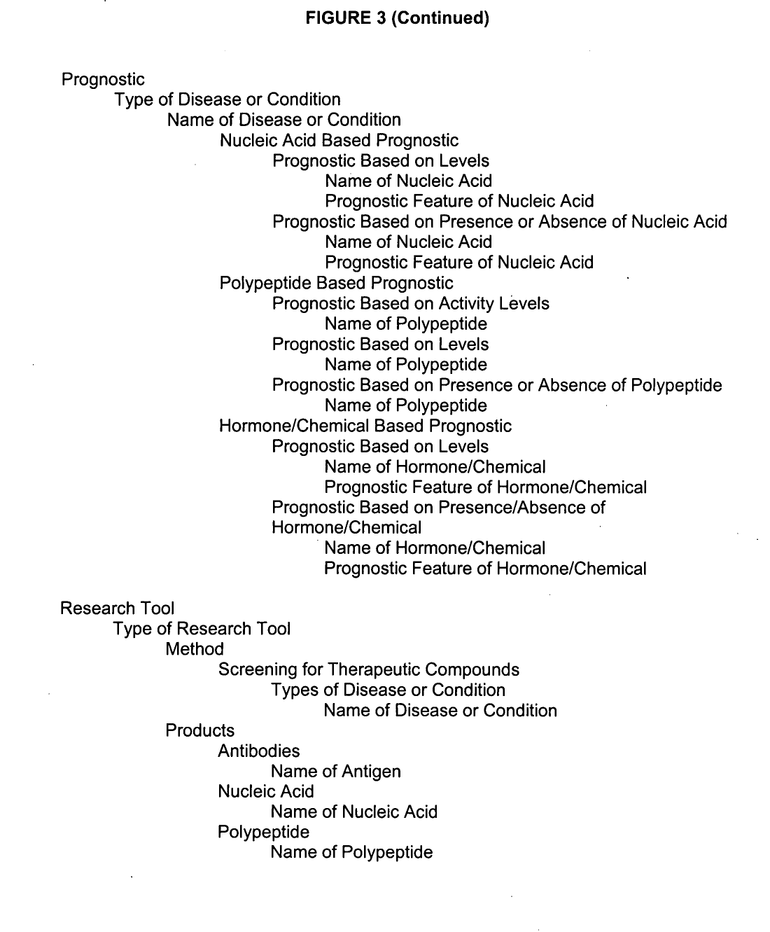

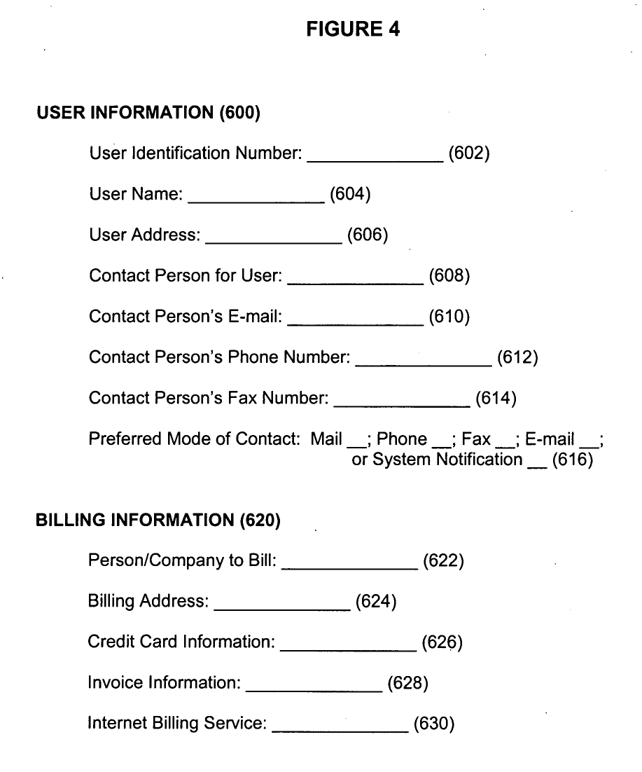

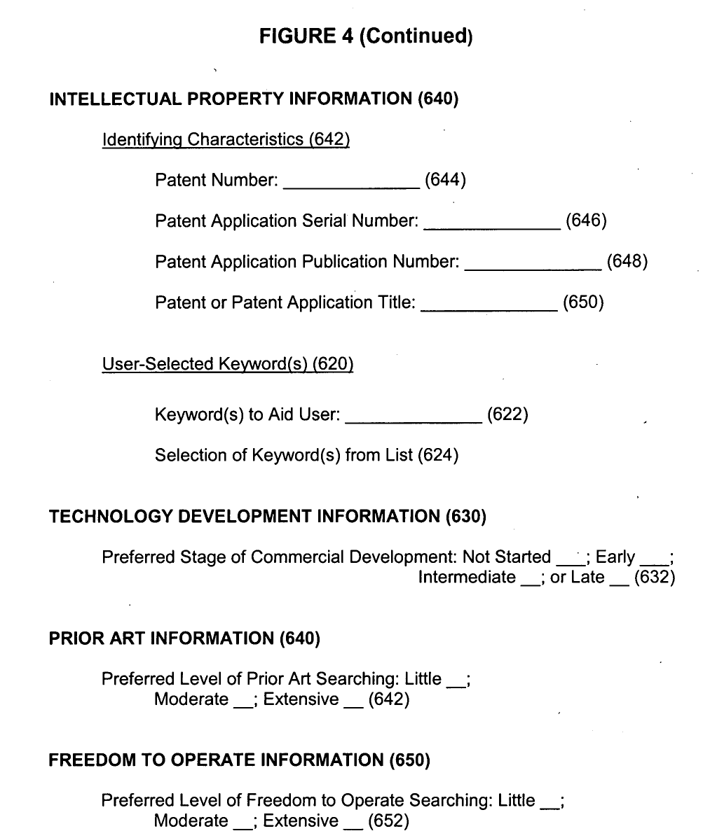

With reference to FIG. 2, a system or method provided herein can be configured such that a provider interface is capable of allowing a provider to enter provider information 200, billing information 220, intellectual property information 240, technology development information 400, prior art information 430, freedom to operate information 450, and prosecution history information 500. Examples of keywords and the hierarchical relationship of a keyword list are provided in FIG. 3. In this example, the technology of the intellectual property can be related to biotechnology. With reference to FIG. 4, a system or method provided herein can be configured such that a user interface is capable of allowing a user to enter user information 600, billing information 620, intellectual property information 640, technology development information 630, prior art information 640, and freedom to operate information 650.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A method for facilitating transfer of intellectual property rights, wherein said method comprises:
(a) presenting providers with a provider interface for entering information about each provider's intellectual property available for sale or license,
(b) receiving information entered into said provider interface by each of said providers,
(c) storing the received information of step (b) in a database as an intellectual property record, wherein each provider's intellectual property forms a separate intellectual property record within said database,
(d) presenting a user with a user interface for entering search information,
(e) receiving said search information entered into said user interface by said user,
(f) searching said database for intellectual property records matching said search information, and
(g) presenting said user with search result output comprising information about any records within said database matching said search information.

2. A method for entering intellectual property information into a database of available intellectual property, wherein said method comprises:
(a) presenting a provider with a provider interface for entering information about intellectual property available for sale or license,
(b) receiving information entered into said provider interface by said provider, and
(c) storing the received information of step (b) in a database for retrieval by a user.

3. The method of claim 2, wherein said provider interface comprises an entry field for an identifying characteristic of the intellectual property to be entered.

4. The method of claim 2, wherein said identifying characteristic is selected from the group consisting of a patent number, a patent application serial number, a patent application publication number, a patent title, and a patent application title.

5. The method of claim 2, wherein step (b) of said method comprises receiving a patent number or application serial number of an issued patent or a serial or publication number of a published patent application.

6. The method of claim 5, wherein said method comprises accessing a public database containing said issued patent or said published patent application to obtain public information about said patent or said published patent application.

7. The method of claim 6, wherein said method comprises presenting said provider with an updated provider interface comprising a field populated with information obtained from said public database.

8. The method of claim 7, wherein said method comprises receiving said patent number or application serial number of said issued patent, and said information obtained from said public database is selected from the group consisting of the issue date of said issued patent, the title of said issued patent, the name of an inventor of said issued patent, the home residency of an inventor of said issued patent, the serial number of the application issuing as said issued patent, the filing date of the application issuing as said issued patent, the serial number of the earliest claimed priority application of said issued patent, the filing date of the earliest claimed priority application of said issued patent, the language of a claim of said issued patent, the use or lack thereof of United States federal funding for developing said issued patent, the name of an assignee of said issued patent, the name of the examiner who examined said issued patent, the number of days of patent term adjustment available to said issued patent, the name of an attorney, agent, or firm of record for said issued patent, the presence or absence of a certificate of correction for said issued patent, the payment due dates for maintenance fees of said issued patent, and the satisfaction or lack thereof of due maintenance fees for said issued patent.

9. The method of claim 7, wherein said method comprises receiving said patent number or application serial number of said issued patent, and said updated provider interface comprises a populated field comprising the issue date of said issued patent, a populated field comprising the title of said issued patent, a populated field comprising the name of each inventor of said issued patent, and a populated field comprising the filing date of the application issuing as said issued patent.

10. The method of claim 7, wherein said method comprises receiving said patent number or application serial number of said issued patent, and said updated provider interface comprises a populated field comprising the serial number of the earliest claimed priority application of said issued patent, a populated field comprising the filing date of the earliest claimed priority application of said issued patent, and a populated field comprising the name of an assignee of said issued patent.

11. A method for retrieving intellectual property information from a database of available intellectual property, wherein said method comprises:
(a) presenting a user with a user interface for entering search information,
(b) receiving said search information entered into said user interface by said user,
(c) searching a database for records matching said search information, wherein said database comprises intellectual property records for intellectual property identified as being available for sale or licensing, wherein each intellectual property record of said database was entered by a provider of said intellectual property, and
(d) presenting said user with search result output comprising either (i) an indication of no matching records or (ii) information obtained from one or more records of said database.

12. The method of claim 11, wherein said user is an owner or employee of a biotechnology investment company.

13. The method of claim 11, wherein said user is a venture capitalist.

14. The method of claim 11, wherein said search information comprises information selected from the group consisting of the name of an owner of intellectual property, the name of an inventor of intellectual property, a patent number, a patent publication number, a patent application serial number, information about the subject matter of intellectual property, keywords describing intellectual property, information about the existence of a commercial product, information about the stage of development of a commercial product, information about the status of data obtained from in vitro or in vivo studies, information about the status of a pre-clinical trial, and information about the status of a clinical trial.

15. The method of claim 11, wherein said method comprises authenticating the identity of said user.

16. The method of claim 11, wherein said method comprises charging said user a fee before or after said step (d).

17. The method of claim 11, wherein said search result output comprises information obtained from two or more records.

18. The method of claim 17, wherein said method comprises ranking the information of said search result output based on said search information.

19. The method of claim 11, wherein said search result output comprises an intellectual property rank for each intellectual property of said search result output.

20. The method of claim 11, wherein said search result output comprises a provider score for each provider or listed owner of each intellectual property of said search result output.
